(19) United States
(12) Patent Application Publication
(10) Pub. No.: US 2010/0080251 A1
(43) Pub. Date: Apr. 1, 2010

(54) LASER AND METHOD FOR GENERATING PULSED LASER RADIATION

(75) Inventors: Jan Symanowski, Jena (DE); Matthias Hoffman, Jena (DE); Michael Ludemann, Erfurt (DE)

Correspondence Address: Ulbrich I.P., Ltd, 7234 W. Timber Ln., Maple Grove, MN, 55369, US

(73) Assignee: JENOPTIK Laser, Optik, Systeme GmbH, Jena (DE)

(21) Appl. No.: 12/565,074

(22) Filed: Sep. 23, 2009

(30) Foreign Application Priority Data
Sep. 26, 2008 (DE) 102008049085.7-54

(51) Int. Cl. H01S 3/115; H01S 3/11; H01S 3/117; H01S 3/10

(52) U.S. Cl. 372/12; 372/10; 372/13; 372/25

(57) ABSTRACT

A laser for generating pulsed laser radiation is provided, having a resonator, a laser-active medium, which is situated in the resonator, a Q-switch, which is situated in the resonator, and which can be put into a first state and a second state to set the resonator quality. The resonator quality is lower in the first state than in the second state. The laser also may have a detection unit, which, when the Q-switch is in the second state, measures the intensity of the building laser pulse and outputs it as an intensity signal. The laser may further have a control unit for controlling the Q-switch, which, as a function of a predetermined pulse duration and the applied intensity signal, switches the Q-switch from the second state into the first state, before the pulse buildup of the laser pulse is completed.

### PRIORITY

The present application claims benefit of German Application No. 102008049085.7-54, filed Sep. 26, 2008, which is hereby incorporated by reference.

### FIELD

The present invention relates to a Q-switched laser for generating pulsed laser radiation.

### BACKGROUND

The difficulty exists in Q-switched lasers that the possible pulse repetition rates are relatively low. Thus, for example, in a known Yb:YAG laser, the maximum pulse repetition rate is approximately 30 kHz. Furthermore, the pulse length of the individual pulses of the pulsed laser radiation also increases with increasing pulse repetition rate.

### SUMMARY

It is an object of certain embodiments of the invention to refine a Q-switched laser so that a higher maximum pulse repetition rate is possible and it is possible with increasing pulse repetition rate to keep the pulse length equal or even select a shorter pulse length.

The object is achieved in particular embodiments by a laser for generating pulsed laser radiation, having a resonator, a laser-active medium situated in the resonator, a Q-switch situated in the resonator, which can be put into one first state and at least one second state to set the resonator quality, the resonator quality being lower in the first state than in the second state, a detection unit, which measures the intensity of the building laser pulse and outputs it as an intensity signal when the Q-switch is in the second state, and having a control unit for controlling the Q-switch, which switches the Q-switch from the second state to the first state as a function of a predetermined pulse duration and the applied intensity signal before the pulse buildup of the laser pulse is completed.

It is therefore possible to shorten the pulse duration and thus set it to desired values. Because the remaining inversion level in the laser-active medium is higher as a result of the termination during the pulse buildup in comparison to the case in which no termination occurs during the pulse buildup, higher repetition rates (e.g., by a factor of 2-10, in particular 3-5) and higher pulse peak powers may be achieved.

The pulse duration and the pulse repetition rate may be set in broad ranges independently of one another using the laser according to the invention. Furthermore, the maximum pulse repetition rate is significantly higher in comparison to a typical Q-switched laser, in which the pulse buildup is not terminated.

In the laser according to certain embodiments of the invention, an intensity value of the rising flank or the falling flank of the laser pulse may be associated with the predetermined pulse duration. In this case, the changeover of the Q-switch is caused upon reaching this intensity value.

The laser is particularly implemented so that the changeover duration of the Q-switch from the second state into the first state is taken into consideration in order to set the desired pulse duration. Furthermore, a delay generated by control electronics of the Q-switch can also be taken into consideration.

The Q-switch can be implemented as an acousto-optic or electro-optic modulator.

Furthermore, the control unit can electronically delay the changeover of the Q-switch from the second state into the first state in order to increase the maximum settable pulse duration.

The laser can have a setting unit at which the predetermined pulse duration and a predetermined pulse repetition rate may be input and which is connected to the control unit, the control unit controlling the Q-switch so that the pulsed laser radiation contains pulses having the predetermined pulse duration and the predetermined pulse repetition rate.

In particular, the setting unit, upon input of the predetermined pulse duration or the predetermined pulse repetition rate, can display for selection the pulse repetition rates or the pulse durations which are then possible. A laser is thus provided in which the pulse duration and pulse repetition rate may be set in the simplest way.

The setting unit can be implemented as a hardware or software module or as a combination of both.

The laser particularly also has a pumping source for pumping the laser-active medium.

Furthermore, the laser contains further elements known to one skilled in the art, which are necessary for operating the laser.

Furthermore, a method is provided for generating pulsed laser radiation in a laser having a resonator, in which a Q-switch, which can be put into a first state and a second state to set the resonator quality, the resonator quality being lower in the first state than in the second state, and a laser-active medium are situated, the intensity of the building laser pulse being measured and output as an intensity signal when the Q-switch is in the second state, and the Q-switch being switched from the second state into the first state, before the pulse buildup of the laser pulse is completed, as a function of a predetermined pulse duration and the intensity signal.

Using this method it is possible to set the pulse duration and pulse repetition rate in broad ranges independently of one another in a Q-switched laser. Furthermore, the pulse repetition rate can be increased significantly in comparison to a typical Q-switched laser.

Refinements of the method according to the invention are disclosed in the dependent claims.

It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

The invention will be commented on in greater detail hereinafter by way of example with reference to the appended drawings in which:

FIG. 1 is a schematic view of a laser according to an example embodiment of the invention;

FIG. 2 is an illustration to explain the pulse generation according to an example embodiment of the invention;

FIG. 3 is a further illustration to explain the pulse generation according to an example embodiment of the invention, and

FIG. 4 is a diagram to explain the possible pulse duration and pulse repetition rates according to an example embodiment of the invention.

### DETAILED DESCRIPTION

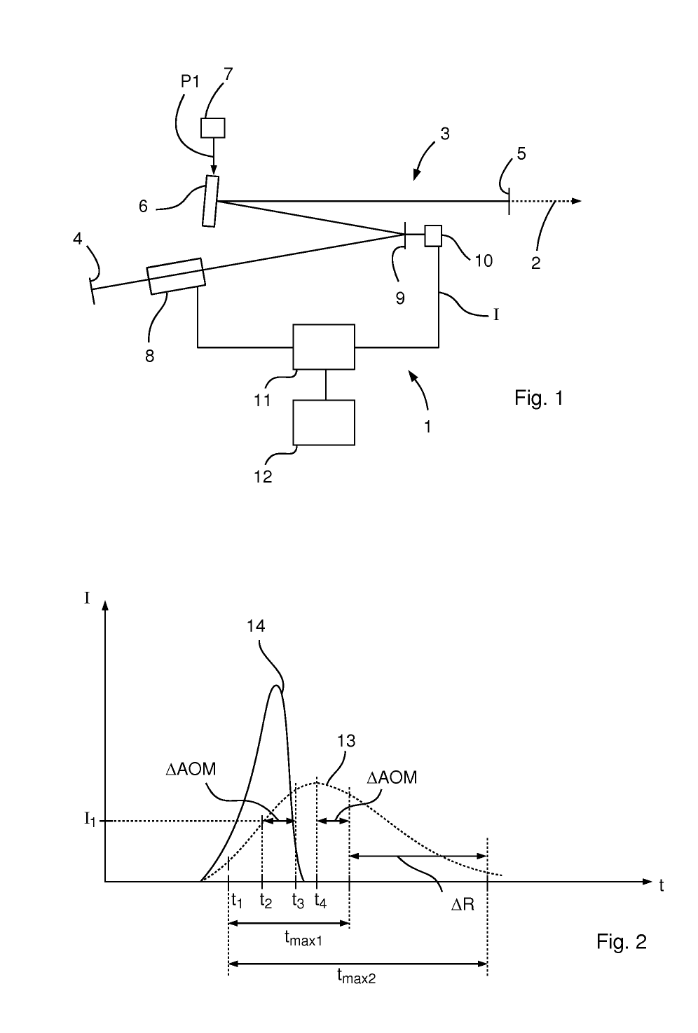

In the example embodiment shown in FIG. 1, the laser 1 for generating pulsed laser radiation 2 comprises a resonator 3 having a highly-reflective terminal mirror 4 and a decoupling mirror 5, whose degree of decoupling is approximately 10%.

A laser-active medium 6 (Yb:YAG) is situated in the resonator 3, which is pumped (arrow P1) using the light of a pumping light source 7 (continuously here).

Furthermore, a Q-switch 8 in the form of an acousto-optic modulator and a deflection mirror 9 are situated in the resonator 3. The deflection mirror 9 decouples a small part of the reflected laser radiation. This part is measured by the detection unit 10, which is situated behind the deflection mirror 9, and output as the intensity signal I.

The laser 1 also comprises a control unit 11, to which the intensity signal I is applied and which can switch the acousto-optic modulator 8 back and forth between its first state of lower quality and its second state of higher quality, and a setting unit 12, at which a desired pulse repetition rate and a desired pulse duration may be set.

The generation of the pulses having the set pulse duration (also referred to hereafter as a regulated pulse) is performed as follows in the laser 1 according to an example embodiment of the invention. The acousto-optic modulator 8 is switched to its first state of lower quality, so that no laser activity occurs because of the higher resonator losses, but the desired level of the population inversion is achieved.

After the changeover of the acousto-optic modulator into its second state of higher quality, the laser activity begins, so that the laser pulse 13 (unregulated pulse) shown by dashed lines in FIG. 2 would be generated if the acousto-optic modulator 8 remained long enough in its second state.

However, the intensity in the resonator and thus also the intensity of the building laser pulse 13 is continuously measured using the detection unit 10 and applied as the intensity signal I to the control unit 11. The control unit 11 is designed so that an intensity value I₁ is associated with the desired pulse duration, so that upon reaching the associated intensity value I₁ at the time t₂, the control unit 11 switches the acousto-optic modulator 8 from its second state into its first state. Because of the large resonator losses which now occur again, the pulse buildup is interrupted and a shorter pulse 14, having higher pulse peak power, leaves the resonator 3.

Since between the application of a switching signal to the acousto-optic modulator 8 for the changeover from its second state into its first state until reaching the first state, a predetermined time duration ΔAOM has passed, the acousto-optic modulator 8 is first switched into its first state at the time t₃. From this moment t₃, the pulse buildup is thus actually terminated, whereby the pulse 14 is generated, whose pulse duration is shorter than the pulse duration of the pulse 13. The remaining higher inversion level ensures a higher achievable repetition rate (by approximately the factor 3 in comparison to the unregulated pulses 13 here) and higher pulse stability.

It is advantageous to determine the intensity during the rising flank of the pulse 13 and use it as a measure for the pulse length to be set. In the example described here, intensity values between the moments t₁ and t₄ may thus be used for setting a desired pulse duration. The minimum possible pulse length is delimited by the switching duration ΔAOM. In the example embodiment described here, the minimal pulse length is between 100 ns and 200 ns.

The maximum settable pulse length tₘₐₓ₁ is determined by the moment t₄ and ΔAOM, as shown in FIG. 2. This maximum pulse length tₘₐₓ₁ approximately 700 ns in the example here.

The pulses 13 and 14, which do not occur simultaneously, of course, are shown in the illustration of FIG. 2 so that the moments of the pulse start are coincident. It can therefore be shown using this illustration that the rising flank of the pulse 14 is steeper than the rising flank of the pulse 13. This is primarily because during the generation of the pulses according to the invention, due to the termination of the pulse buildup performed during the generation of each individual pulse, the inversion level remaining in the resonator is higher than the case of the unregulated generation of the pulses 13.

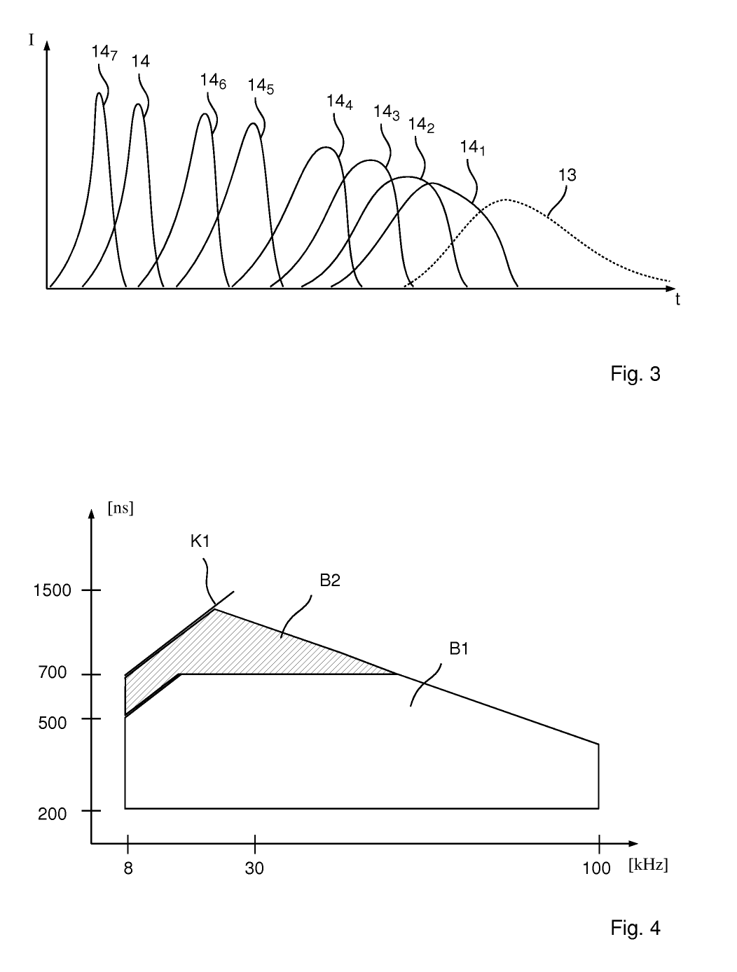

Various laser pulses 14, 14₁, 14₂, . . . 14₇, which can be generated, are shown in comparison to the laser pulse 13 for the unregulated case in FIG. 3, each laser pulse 13, 14, 14₁, . . . 14₇ being shown on the time axis t relative to the trigger moment, at which the control unit 11 activates the acousto-optic modulator 8 for the changeover from its first state into its second state. The trigger moment is not shown.

It can be seen from the illustration that the regulated pulse 14₁ having the longest pulse duration has a very similar pulse shape as the unregulated pulse 13. The termination of the pulse generation is discernable from the steep drop from the middle of the falling flank.

As the pulse duration of the pulses 14₂, 14₃, . . . 14 and 14₇ becomes shorter, the pulse peak power (higher pulses) increases and the time until the beginning of the pulse generation relative to the triggering moment decreases (pulses “slip” to the left in FIG. 3). This behavior is to be attributed to the higher remaining inversion level, which was already described.

A diagram is shown in FIG. 4, in which the possible pulse widths (along the abscissa) are shown as a function of the settable repetition rate (along the ordinate). The curve K1 drawn in the diagram shows the case in which the pulse width is not controlled. In this case, the acousto-optic modulator 8 is always only switched from its second state into its first state during the generation of the pulses 13 when the pulse generation is entirely completed. As may be inferred from the curve K1, pulse repetition rates in the range from 8-30 kHz are possible.

The range B1 shown in the diagram of FIG. 4 indicates the range in which the pulse width is settable using the termination of the pulse generation according to an example embodiment of the invention. Pulse widths in the range from 200-700 ns are possible, significantly higher pulse repetition rates being settable than during the generation of the unregulated pulses 13, however. This is primarily because, upon the shortening of the pulse duration by interruption of the pulse buildup in the described way, the remaining inversion level in the laser-active medium 6 is higher than in the case in which the pulse generation is not interrupted, so that because of the higher remaining inversion, the pulse repetition rate can be increased significantly and nonetheless outstanding pulse stability exists.

The pulse repetition rate and the pulse width can be selected freely in the range B1 schematically shown in FIG. 4.

Furthermore, it is possible in the laser 1 according to the invention to increase the controlled pulse width of the pulses 14 in that, in addition to the existing modulator switching duration ΔAOM, an electronic delay ΔR is introduced using the control unit 11. This results in a greater maximum pulse duration Tₘₐₓ₂, as schematically shown in FIG. 2. This greater pulse duration includes the shaded range B2 shown in FIG. 4, so that value pairs of pulse duration and pulse repetition rate lying in this range are also settable and B1 and B2 are included.

In particular, the setting unit 12 can be implemented so that, upon input of a desired pulse width (or pulse duration), it offers the pulse repetition rates possible at this pulse duration (according to the range B1 and optionally according to the range B2) for selection. The value pair of pulse duration and pulse repetition rate which is then selected is applied via the setting unit 12 to the control unit 11, which activates the acousto-optic modulator 8 accordingly, so that the pulses 14 of the pulsed laser radiation 2 having the desired pulse duration and pulse repetition rate occur. The setting unit 12 may also display a set or range of possible pulse widths for selection upon input of a desired pulse repetition rate.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

1. A laser for generating pulsed laser radiation, comprising:
a resonator;
a laser-active medium, which is situated in the resonator;
a Q-switch, which is situated in the resonator, and which can be put into a first state and a second state to set the resonator quality, the resonator quality being lower in the first state than in the second state;
a detection unit, which, when the Q-switch is in the second state, measures the intensity of the building laser pulse and outputs it as an intensity signal; and
a control unit for controlling the Q-switch, which, as a function of a predetermined pulse duration and the intensity signal, switches the Q-switch from the second state into the first state, before the pulse buildup of a laser pulse is completed.

2. The laser according to claim 1, wherein an intensity value of a rising flank of the laser pulse is associated with a predetermined pulse duration.

3. The laser according to claim 1, wherein an intensity value of a falling flank of the laser pulse is associated with a predetermined pulse duration.

4. The laser according to claim 1, wherein the Q-switch is implemented as an acousto-optic modulator.

5. The laser according to claim 1, wherein the Q-switch is implemented as an electro-optical modulator.

6. The laser according to claim 1, wherein the control unit includes an electronic delay for performing the switch of the Q-switch from the second state into the first state.

7. The laser according to claim 1, having a setting unit, at which the predetermined pulse duration and a predetermined pulse repetition rate may be input, and which is connected to the control unit, wherein the control unit controls the Q-switch so that the pulses of the pulsed laser radiation occur having the predetermined pulse duration and the predetermined pulse repetition rate.

8. The laser according to claim 7, wherein the setting unit displays the possible pulse repetition rates or the possible pulse durations, respectively, for selection upon input of the predetermined pulse duration or the predetermined pulse repetition rate.

9. A method for generating pulsed laser radiation in a laser, comprising:
providing a resonator, in which a Q-switch and a laser-active medium are situated, the Q-switch configured to be put into a first state and a second state to set the resonator quality, the resonator quality being lower in the first state than in the second state;
determining if the Q-switch is in the second state;
measuring the intensity of the building laser pulse;
outputting the intensity of the building laser pulse as an intensity signal;
evaluating the intensity signal and a predetermined pulse duration to determine whether to switch the Q-switch from the second state into the first state; and
switching the Q-switch from the second state into the first state before the pulse buildup of the laser pulse is completed

10. The method according to claim 9, further comprising associating an intensity value of a rising flank of the laser pulse with the predetermined pulse duration.

11. The method according to claim 9, further comprising associating an intensity value of a falling flank of the laser pulse is with the predetermined pulse duration

12. The method according to claim 9, wherein providing a resonator includes implementing an acousto-optic modulator as the Q-switch.

13. The method according to claim 9, wherein providing a resonator includes implementing an electro-optical modulator as the Q-switch.

14. The method according to claim 9, further comprising setting the pulse duration using an electronic delay.

15. The method according to claim 9, further comprising:
inputting the predetermined pulse duration and a predetermined pulse repetition rate into a setting unit; and
controlling the Q-switch so that the pulses of the pulsed laser radiation occur having the predetermined pulse duration and the predetermined pulse repetition rate.

16. The method according to claim 15, further comprising, displaying on the setting unit at least one of a set of possible pulse repetition rates and a set of possible pulse durations.
